(19) United States
(12) Patent Application Publication
(10) Pub. No.: US 2002/0000015 A1
(43) Pub. Date: Jan. 3, 2002

(54) Spring shaft for pipe cleaning apparatus

(76) Inventor: Helmut Rothenberger, Konigstein (DE)

Correspondence Address: FULBRIGHT & JAWORSKI, LLP, 666 FIFTH AVE, NEW YORK, NY, 10103-3198, US

(21) Appl. No.: 09/887,738

(22) Filed: Jun. 22, 2001

(30) Foreign Application Priority Data
Jul. 1, 2000 (DE) 100 32 144.5-15

(51) Int. Cl. B08B 9/027

(52) U.S. Cl. 15/104.09; 15/104.16; 15/104.31; 15/104.33

(57) ABSTRACT

A spring shaft (1) for cleaning pipelines consists of a coil spring (2) with windings (3, 3a, 3b, 3c) of spring steel and with a rotation axis (RA) and a spiral winding axis (WA). In order to give the spring shaft (1) a particular cleaning function, the windings (3, 3a, 3b, 3c) have at least on their outside (4) a cross section departing from the circular shape, with at least one edge (K) acting on the pipeline. At the same time it is possible to provide the outside (4) with at least one longitudinal groove (8) following the windings (3c), or to configure the cross section of the windings (3a, 3b) as a square whose outside edge (4a) runs parallel to the rotation axis (RA) or whose surface diagonal (4b) runs radially to the rotation axis (RA). Lastly, it is possible to provide the outside (4) with a profile (5) in which projections and grooves alternate.

The invention relates to a spring shaft for cleaning pipelines pursuant to the preamble of claim 1.

Such spring shafts, which are also called cleaning coils, consist usually of a coiled drawn steel wire of round cross section with a smooth surface. They are provided at their ends with couplings for connecting to a great variety of tools, such as drills, cutterheads, thrashing chain heads, pipe brushes, root cutters, mud drills, etc. The machines that drive them and their manner of operation are explained in the detailed description.

The known spring shafts are substantially of only a drive character. The mounted tools are inserted into clogged pipelines by the spring shaft, which can also be composed of several spring shafts, and “work their way” through elbows, branch lines etc. They are withdrawn by reversing their sense of rotation, and in the case of stubborn blockage they can also perform periodical forward and reverse movements.

DE 38 32 716 C2 discloses a spring shaft with a cross section in the shape of a rectangle or trapezoid, from which two opposite edges run parallel to the axis of the spring shaft. The outer edge of these helically running edges lies in an imaginary cylindrical surface if one considers the outstretched position of the spring shaft. Thus the corners of this cross section which also ran helically can exercise no cleaning action on the inner walls of pipes, even when the spring shaft is passed through bends or elbows because in these cases the outer edge of the cross section contacts the bend only tangentially on its smallest radius of curvature; in other words the cross sectional edges in the pipe bend cannot come in contact with the inside surface of the pipe.

The known apparatus serves for lining the inner walls of pipes, and at the end of the spring shaft a plurality of successive rotationally symmetrical spreader bodies are arranged for a fluid coating material which is fed through a hose running inside of the spring shaft, and is distributed on the pipe wall by the spreader bodies when the spring shaft is withdrawn. The spring shaft has only a driving function. For the sake of limiting changes in diameter when the spring shaft is rotated forward and backward, the latter has a rectangular or trapezoidal cross section defined by formulas. The use of the spring shaft itself as a cleaning device is neither disclosed nor suggested, since it is expressly stated that, for cleaning the pipe's inside wall, cleaning devices must be attached to the forward end of the spring shaft.

The invention is addressed to the problem of improving such spring shafts so that, while preserving their driving function itself, they can exercise a cleaning action.

The solution of the stated problem is accomplished according to the invention by the features in the specific part of claim 1.

The stated problem is solved to the full extent by this solution, i.e., while retaining their driving function itself, they exercise a cleaning action and scrape, so to speak, even stubborn incrustations from the pipe walls, which can consist of ceramics, cast iron or plastic.

It is especially advantageous, as a result of further embodiments of the invention, if, either individually or in combination:

the exterior is provided with at least one longitudinal groove following the coils,

the cross section of the coils is a square whose one surface diagonal run at least substantially radially to the axis of rotation,

the exterior is provided with a profile in which projections and grooves alternate,

the projections are sharp-edged at least in the circumferential direction of the coil axis,

the projections are surrounded by the grooves,

the grooves form two groups of which the grooves of the one group run substantially in the circumferential direction of the coil axis and the grooves of the other group run at an angle thereto,

the grooves of both groups intersect at an angle between 30 and 60 degrees,

the projections overlap in the circumferential direction of the coil axis such that drive jaws of a machine driving the spring shaft cannot drop into the grooves, and/or if

the projections are rhomboidal in plan.

The shaping can be done by rolling, grinding or milling, also on the wire before winding, if desired. In this case heed must be paid only to precise guidance in the winding.

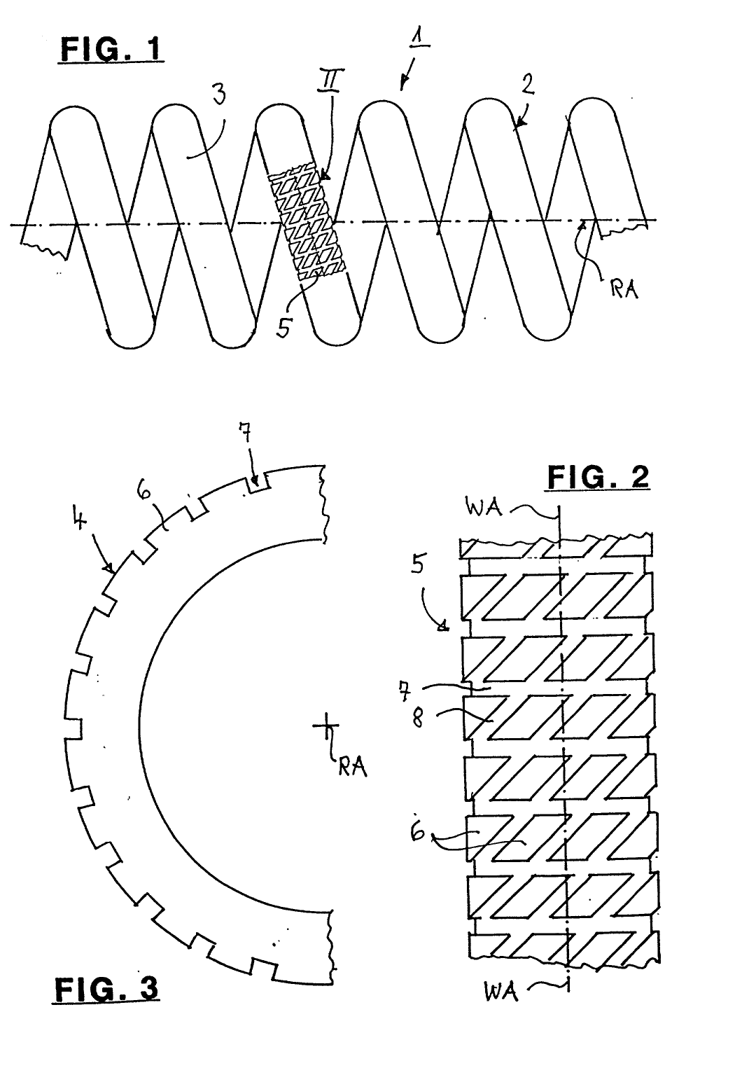

Embodiments of the invention are described below in conjunction with FIGS. 1 to 4, wherein:

FIG. 1 is a side view of a section of the length of a spring shaft of a first embodiment,

FIG. 2 the section II from FIG. 1 on a larger scale,

FIG. 3 a section through a half turn of the spring shaft of FIG. 1, also on a scale larger than in FIG. 1, and

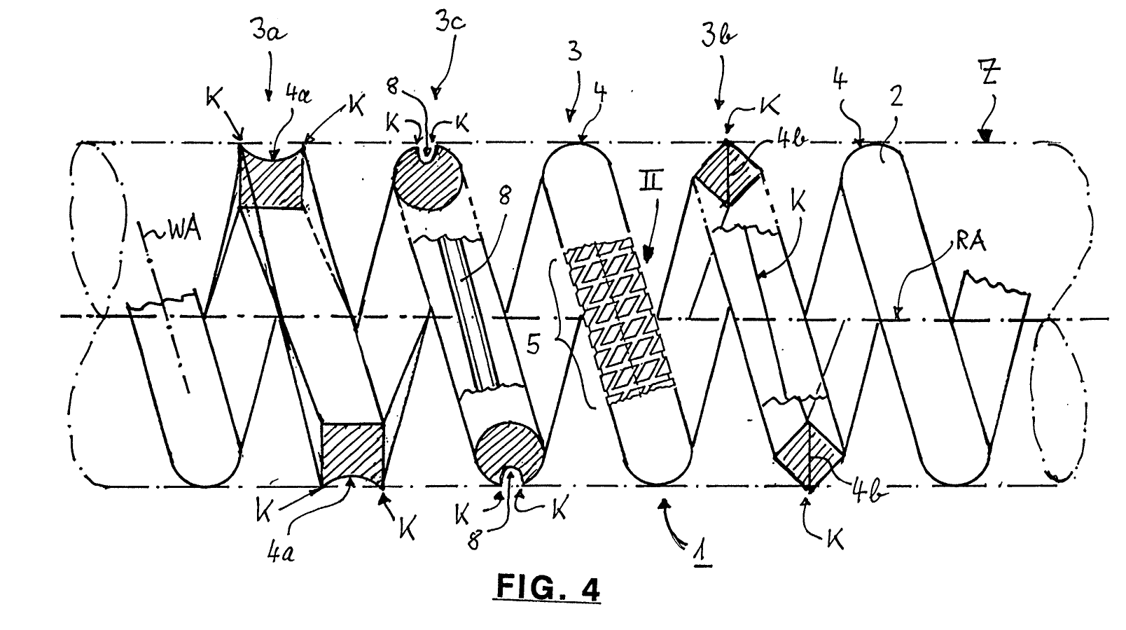

FIG. 4 various additional embodiments on a section of the length of a spring shaft on a scale larger than in FIG. 1.

In FIGS. 1 to 3 there is shown a spring shaft 1 for a pipe cleaning apparatus not shown, which consists in a known manner of a portable or mobile driving machine having an electric motor and a clutch driven thereby. This clutch contains sector-shaped clutch jaws which can be urged radially against the spring shaft, the pressure applied determining the torque of the spring shaft.

The spring shaft 1 consists of a coil spring 2 of spring steel, with an axis of rotation RA and a plurality of windings 3 whose exterior 4 is provided with a profile 5 in which projections 6 and grooves 7 and 8 alternate. The projections 6 are sharp-edged at least in the direction of the circumference of the winding axis (WA-WA). In this case the projections 6 are surrounded by the grooves 7 and 8. The profile 5 extends, of course, over the entire length of the spring shaft 1.

The grooves 7 and 8 form two sets, of which grooves 7 of the one set run substantially in the direction of the circumference of the winding axis (WA-WA) and grooves 8 of the other set run at an angle thereto, which is between 30 and 60 degrees. The arrangement is such that the projections 6 overlap in the direction of the circumference of the winding axis (WA-WA) such that clutch jaws of a machine driving the spring shaft cannot drop into grooves 8. For this purpose the projections 6 are rhomboidal in plan.

FIG. 4 shows various additional embodiments on a section of the length of a spring shaft 1. The two ends represent correspond to the state of the art with a cross section of circular shape. The outsides lie—as seen in the outstretched position—in an imaginary cylinder surface Z represented in broken lines.

The winding 3a consists of a wire with such a cross section (shown twice, hatched) that its external helical shaped surface 4a is concave, so that two sharp edges K, each with an angle of aperture of less than 90 degrees are formed, which enclose between them a circumferential groove. Thus two sharp edges K are formed, which act on the pipe walls and there scrape off incrustations.

The winding 3b consists of a wire with a square cross section (shown twice, hatched), of which the surface diagonal 4b runs radially to the axis of rotation RA. Thus a sharp edge K is formed which acts on the pipe walls and scrapes away incrustations. The square cross section can be square, rectangular, diamond-shaped or trapezoid, of which, in winding 3a, at least the outer edge 4a can also be concave to enhance the scraping action of the edges K.

The winding 3c consists of a wire with an originally circular cross section (shown twice, hatched), in whose exterior a groove 8 following windings 3c is created. Here again two sharp edges K are formed, which act on the pipe walls and scrape off incrustations.

Of course, the windings 3, 3a, 3b and 3c pertain to different spring shafts. Windings 3a to 3c produce in addition to the scraping action a “screw guidance” of the spring shaft at all points at which the spring shaft forcibly contacts the pipe wall, e.g., in elbows or junctions. The compression of the spring shaft by the force with which it is driven is then reduced, and the driving forces then develop in part “on the spot.” The same applies to withdrawal force.

1. Apparatus for the cleaning of interior pipe walls by means of a coil spring (2) forming a spring shaft (1) with windings (3, 3a, 3b, 3c) of spring steel and with a rotation axis (RA) and a coiled winding axis (WA-WA), the windings (3, 3a, 3b, 3c) having at least on their exterior (4) a cross section different from the circular shape, characterized in that at least the exterior (4) of the windings is profiled such that the spring shaft (1) itself acts with at least one edge (K) scrapingly on contamination of the pipe walls.

2. Apparatus according to claim 1, characterized in that the exterior (4) is provided with at least one longitudinal groove (8) following the windings (3, 3c).

3. Apparatus according to claim 1, characterized in that the cross section of the windings (3b) is a square whose one surface diagonal (4b) runs at least substantially radially to the rotation axis (RA).

4. Apparatus according to claim 1, characterized in that the exterior (4) is provided with a profile (5) in which projections (6) and grooves (7, 8) alternate.

5. Apparatus according to claim 4, characterized in that the projections (6) are sharpedged at least in a circumferential dire ction of the winding axis (WA-WA).

6. Apparatus according to claim 4, characterized in that the projections (6) are surrounded by the grooves (7, 8).

7. Apparatus according to claim 4, characterized in that the grooves (7, 8) form two groups of which the grooves (7) of the one group run substantially in the circumferential direction of the winding axis (WA-WA) and the grooves (8) of the other group at an angle thereto.

8. Apparatus according to claim 7, characterized in that the grooves (7, 8) of both groups cross one another at an angle between 30 and 60 degrees.

9. Apparatus according to claim 8, characterized in that the projections (6) overlap one another in the circumferential direction of the winding axis (WA-WA) such that drive jaws of a driving machine for the apparatus (1) cannot drop into the grooves (8).

10. Apparatus according to claim 8, characterized in that the projections (6) are of rhomboidal shape in plan.
